(19) United States
(12) Patent Application Publication
(10) Pub. No.: US 2026/0064146 A1
(43) Pub. Date: Mar. 5, 2026

(54) LOW DROP OUT REGULATOR CIRCUIT

(71) Applicant: Apple Inc., Cupertino, CA (US)

(72) Inventors: Hanan COHEN, Cupertino, CA (US); Mengde Wang, Cupertino, CA (US)

(73) Assignee: Apple Inc., Cupertino, CA (US)

(21) Appl. No.: 18/824,237

(22) Filed: Sep. 4, 2024

(51) Int. Cl. G05F 1/59

(52) U.S. Cl. CPC G05F 1/59

(57) ABSTRACT

The present disclosure describes a power management system that includes a flipped voltage follower (FVF) low drop out (LDO) regulator circuit. The FVF LDO regulator circuit includes a pass device, a first control transistor, a second control transistor, a current bias and voltage bias device, and a resistor device. The first control transistor includes a first gate terminal, a first source/drain (S/D) terminal electrically coupled to the pass device, and a second S/D terminal. The current bias and voltage bias device is electrically coupled to the second S/D terminal. The second control transistor includes a second gate terminal electrically coupled to the first gate terminal, a third S/D terminal electrically coupled to the first S/D terminal and the pass device, and a fourth S/D terminal. Further, the resistor device is electrically coupled to the fourth S/D terminal.

### FIELD

This disclosure relates to a low drop out (LDO) regulator circuit and, more particularly, to a flipped voltage follower (FVF) LDO regulator circuit with improved transient response and power consumption.

### BACKGROUND

Flipped voltage follower (FVF) low drop out (LDO) regulator circuits can be used in power management systems to regulate an output voltage derived from a higher voltage input. For example, FVF LDO regulator circuits can be used in mobile power management systems that require a compact size and a clean supply voltage, where these regulator circuits maintain a low dropout between input and output voltages. Benefits of FVF LDO regulator circuits, among others, include their ability to maintain a stable output voltage with load variations, be immune to changes in ambient temperature, and maintain stability over time.

### SUMMARY

Embodiments of the present disclosure include a power management system that includes an FVF LDO regulator circuit. The FVF LDO regulator circuit can include a first loop portion and a second loop portion. The first loop portion can serve as a DC regulation loop for the FVF LDO regulator circuit. The first loop portion can include an adjustable current source circuit to provide a bias current to the FVF LDO regulator circuit based on a mode of operation (e.g., a low power mode of operation and a high power mode of operation). The second loop portion can increase a bandwidth of the FVF LDO regulator circuit, while minimizing circuit area impact to the FVF LDO regulator circuit. In addition to increasing the bandwidth, the second loop portion can include an adjustable pass device to adjust a power consumption of the FVF LDO regulator circuit based on a load current consumed by a load circuit.

Embodiments of the present disclosure include a circuit with a pass device, a first control transistor, a second control transistor, a current bias and voltage bias device, and a resistor device. The first control transistor includes a first gate terminal, a first source/drain (S/D) terminal electrically coupled to the pass device, and a second S/D terminal. The current bias and voltage bias device is electrically coupled to the second S/D terminal of the first control transistor. The second control transistor includes a second gate terminal electrically coupled to the first gate terminal of the first control transistor, a third S/D terminal electrically coupled to the first S/D terminal and the pass device, and a fourth S/D terminal. Further, the resistor device is electrically coupled to the fourth S/D terminal of the second control transistor.

Also, embodiments of the present disclosure include a method for operating a power management system electrically coupled to a load circuit. The method includes sourcing, through a pass device of an LDO regulator circuit, a load current. The method also includes adjusting a resistance of the pass device in response to a voltage level associated with the load current being above a predetermined voltage threshold level and adjusting a current bias of the LDO regulator circuit in response to the load current being below a predetermined current threshold level. Further, the method includes monitoring the load current in response to the load current being below the predetermined current threshold level.

Further, embodiments of the present disclosure include a system with an LDO regulator circuit electrically coupled to a load circuit. The load circuit is configured to generate a load current. The LDO regulator circuit is configured to source the load current, where the LDO regulator circuit includes an adjustable pass device, a first control transistor, a second control transistor, and an adjustable current source circuit. The adjustable pass device is configured to increase a current provided by a power supply voltage to the load circuit in response to a supply voltage associated with the load current being below a predetermined voltage threshold. The first control transistor is electrically coupled to the adjustable pass device. The second control transistor is electrically coupled to the first control transistor and the pass device. The adjustable current source circuit is configured to adjust a bias current based on the load current. The LDO regulator circuit also includes an adjustable resistor device configured to adjust a resistance between the second control transistor and ground. The LDO regulator circuit further includes (i) a first capacitor device electrically coupled to the pass device, the first control transistor, and the second control transistor and (ii) a second capacitor device electrically coupled to the pass device and to the second control transistor.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is an illustration of an electronic device, according to some embodiments.

FIG. 2 is an illustration of a power management system electrically coupled to a load circuit, according to some embodiments.

FIG. 3 is an illustration of a current bias and a voltage bias device with other circuit components of a power management system, according to some embodiments.

FIG. 4 is an illustration of an adjustable transistor in a current source circuit of a power management system, according to some embodiments.

FIG. 5 is an illustration of an adjustable resistor device in a power management system, according to some embodiments.

FIG. 6 is an illustration of an adjustable pass device in a power management system, according to some embodiments.

FIG. 7 is an illustration of method for operating a power management system electrically coupled to a load circuit, according to some embodiments.

FIG. 8 is an illustration of various exemplary systems or devices that can include the disclosed embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

It is noted that references in the specification to “one embodiment,” “an embodiment,” “an example embodiment,” and “exemplary” indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

In some embodiments, the terms “about” and “substantially” can indicate a value of a given quantity that varies within 20% of the value (e.g., ±1%, ±2%, ±3%, ±4%, ±5%, ±10%, ±20% of the value). These values are merely examples and are not intended to be limiting. The terms “about” and “substantially” can refer to a percentage of the values as interpreted by those skilled in relevant art(s) in light of the teachings herein.

It is to be understood that the phraseology or terminology herein is for the purpose of description and not of limitation, such that the terminology or phraseology of the present specification is to be interpreted by those skilled in relevant art(s) in light of the teachings herein.

The following disclosure describes aspects of a power management system electrically coupled to a load circuit. In some embodiments, the circuit topology of the power management system can be a flipped voltage follower (FVF) low drop out (LDO) regulator circuit. The FVF LDO regulator circuit can include a first loop portion and a second loop portion. The first loop portion can serve as a DC regulation loop for the FVF LDO regulator circuit. The first loop portion can include an adjustable current source circuit to provide a bias current to the FVF LDO regulator circuit based on a mode of operation (e.g., a low power mode of operation and a high power mode of operation). The second loop portion can increase a bandwidth of the FVF LDO regulator circuit, while minimizing circuit area impact to the FVF LDO regulator circuit. For example, the bandwidth can be tuned by an adjustable resistor device in the second loop portion. In addition to increasing the bandwidth, the second loop portion can include an adjustable pass device to adjust a power consumption of the FVF LDO regulator circuit based on a load current consumed by the load circuit.

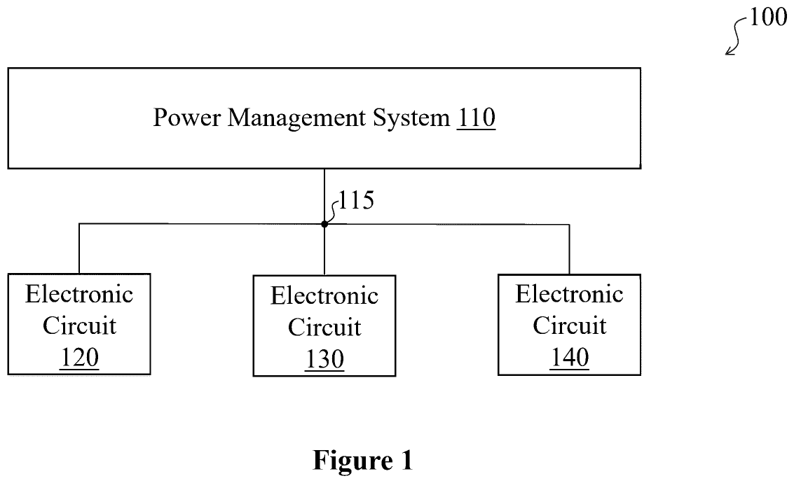

FIG. 1 is an illustration of an electronic device 100, according to some embodiments. Electronic device 100 includes a power management system 110 and electronic circuits 120, 130, and 140. Power management system 110 can convert a source of incoming power (e.g., a battery or any other suitable power supply source) to desired voltages/currents required by electronic circuits 120, 130, and 140. In some embodiments, power management system 110 provides a supply voltage 115 to electronic circuits 120, 130, and 140 and regulates supply voltage 115 as electronic circuits 120, 130, and 140 vary in voltage and/or current consumption (also referred to herein as a “load voltage” and “load current” or cumulatively as a “load”). Supply voltage 115 can be set at a suitable voltage level for electronic circuits 120, 130, and 140, such as a power supply voltage (e.g., 1.0 V, 1.2 V, 1.8 V, 2.4 V, 3.3 V, and 5.0 V). Though electronic device 100 shows power management system 110 with a single supply voltage 115 electrically coupled to electronic circuits 120, 130, and 140, electronic device 100 is not limited to this circuit architecture. For example, power management system 110 can provide different supply voltages to one or more of electronic circuits 120, 130, and 140. These other circuit architectures are within the scope of the present disclosure.

Electronic circuits 120, 130, and 140 can be any suitable type of electronic device, such as a processor circuit, a memory circuit, an input/output (I/O) circuit, a peripheral circuit, and combinations thereof. In some embodiments, the processor circuit can include a general-purpose processor to perform computational operations, such as a central processing unit. The processor circuit can also include other types of processing units, such as a graphics processing unit, an application-specific circuit, and a field-programmable gate array circuit. In some embodiments, the memory circuit can include any suitable type of memory, such as Dynamic Random Access Memory, Static Random Access Memory, Read-Only Memory, Electrically Programmable Read-Only Memory, non-volatile memory, and combinations thereof.

In some embodiments, the I/O circuit can coordinate data transfer between one of electronic circuits 120, 130, and 140 (e.g., a processor circuit) and a peripheral circuit. The I/O circuit can implement a version of Universal Serial Bus protocol or IEEE 1394 (Firewire®) protocol, according to some embodiments. Further, in some embodiments, the I/O circuit can perform data processing to implement networking standards, such as an Ethernet (IEEE 802.3) networking standard. Examples of the peripheral circuit can include storage devices (e.g., magnetic or optical media-based storage devices, including hard drives, tape drives, CD drives, DVD drives, and any suitable storage device), audio processing systems, and any suitable type of peripheral circuit, according to some embodiments.

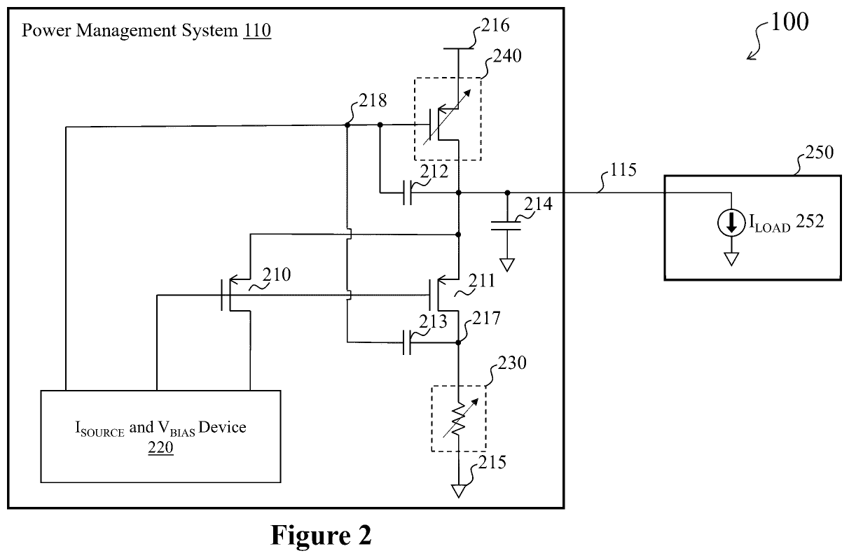

FIG. 2 is an illustration of power management system 110 electrically coupled to a load circuit, according to some embodiments. Power management system 110 includes a first control transistor 210, a second control transistor 211, a first capacitor device 212, a second capacitor device 213, a third capacitor device 214, a current bias and voltage bias device 220 (also referred to herein as “I_{BIAS} and V_{BIAS} device 220”), a resistor device 230, and a pass device 240, according to some embodiments. Power management system 110 provides supply voltage 115 to a load circuit 250—which can be represented by a load current 252 associated with one or more of electronic circuits 120, 130, and 140—and regulates supply voltage 115 as load circuit 250 varies in load, according to some embodiments. First capacitor device 212, second capacitor device 213, and third capacitor device 214 set frequency response and stability characteristics for power management system 110, according to some embodiments.

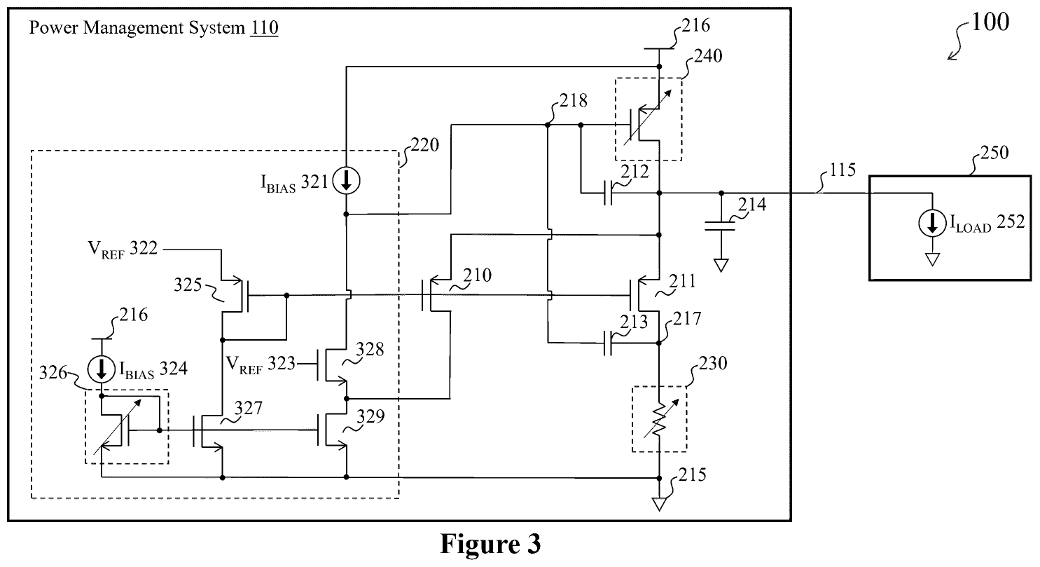

FIG. 3 is an illustration of IASs and V_{BIAS} device 220 with other circuit components of power management system 110, according to some embodiments. I_{BIAS} and V_{BIAS} device 220 includes a first current source circuit 321, a first reference voltage source 322, a second reference voltage source 323, a second current source circuit 324, a first transistor 325, a second transistor 326, a third transistor 327, a fourth transistor 328, and a fifth transistor 329. In some embodiments, I_{BIAS} and V_{BIAS} device 220 can set one or more operating conditions of one or more components in power management system 110 (e.g., first control transistor 210, second control transistor 211, and pass device 240).

Second current source circuit 324, second transistor 326, third transistor 327, and fifth transistor 329 can be electrically coupled to one another and operate as a current mirror circuit to provide a bias current to third transistor 327 and fifth transistor 329—thus providing a bias current to power management system 110. In some embodiments, second current source circuit 324 can include an arrangement of transistors that provide a substantially constant current, such as transistors arranged in a common source configuration. Second transistor 326, third transistor 327, and fifth transistor 329 can each be an n-channel metal-oxide-semiconductor (NMOS) transistor, each with a source terminal electrically coupled to a ground supply voltage 215 (e.g., 0 V), according to some embodiments.

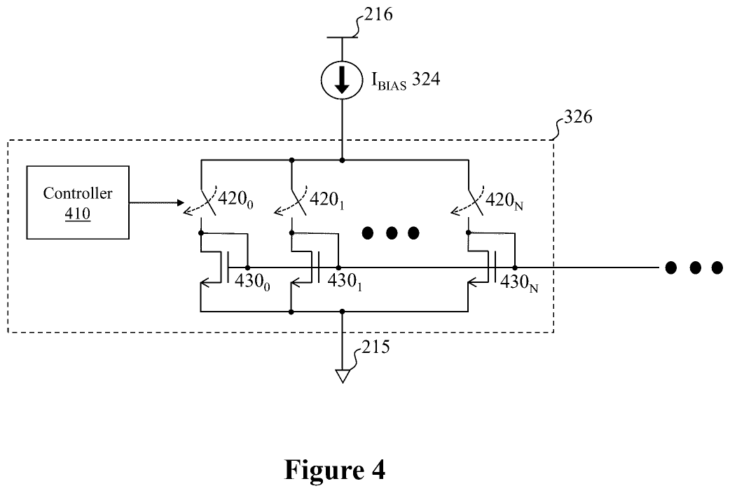

In some embodiments, second transistor 326 can be adjustable, where one or more instances of second transistor 326 can be selected to adjust a current that is mirrored to third transistor 327 and fifth transistor 329. FIG. 4 is an illustration of an adjustable second transistor 326, according to some embodiments. A controller device 410 can activate and deactivate (e.g., open and close, respectively) switch devices 420₀-420_{N} electrically coupled to corresponding transistors 430₀-430_{N} (where N≥1 and each of transistors 430₀-430_{N} is representative of second transistor 326) to adjust an effective resistance across selected transistors 430₀-430_{N}. In some embodiments, each of transistors 430₀-430_{N} can be an NMOS transistor.

As a number of transistors 430₀-430_{N} are selected (e.g., increasing the number of transistors 430₀-430_{N} electrically coupled to one another in parallel), the resistance across selected transistors 430₀-430_{N} decreases. In turn, a voltage at gate terminals of third transistor 327 and fifth transistor 329 (of FIG. 3) decreases, thus decreasing a current (e.g., the bias current) provided by third transistor 327 and fifth transistor 329. Conversely, as the number of transistors 430₀-430_{N} are deselected (e.g., decreasing the number of transistors 430₀-430_{N} electrically coupled to one another in parallel), the resistance across selected transistors 430₀-430_{N} increases. In turn, the voltage at gate terminals of third transistor 327 and fifth transistor 329 increases, thus increasing the current (e.g., the bias current) provided by third transistor 327 and fifth transistor 329.

In some embodiments, controller device 410 can monitor transient events associated with load current 252 and select one or more transistors 430₀-430_{N} accordingly. Controller device 410 can sample load current 252 consumed by load circuit 250 over a period of time and compare the sampled load current to a predetermined current threshold level, according to some embodiments. The predetermined current threshold level can be based on an activity level of load circuit 250. For example, if load circuit 250 is idle and draws little to no load current 252 from power management system 110, then the predetermined current threshold level can be set to a value indicative of this operating condition. Here, controller device 410 can select one or more transistors 430₀-430_{N} to decrease the current (e.g., the bias current) provided by third transistor 327 and fifth transistor 329. If load circuit 250 is active and draws load current 252 that is above the predetermined current threshold level, then controller device 410 can deselect one or more transistors 430₀-430_{N} to increase the current (e.g., the bias current) provided by third transistor 327 and fifth transistor 329.

A benefit of selecting transistors 430₀-430_{N} based on operating conditions of power management system 110, among others, is that a power consumption of power management system 110 can be adjusted based on a mode of operation. For example, in a low power mode of operation (e.g., when power management system 110 is idle or when no or a small amount of load current 252 is consumed by load circuit 250), the number of transistors 430₀-430_{N} selected by controller device 410 can be increased to lower the current provided by third transistor 327 and fifth transistor 329, thus decreasing the power consumed by power management system 110. Conversely, in a high power mode (e.g., where a high load current 252 is consumed by load circuit 250), the number of transistors 430₀-430_{N} selected by controller device 410 can be decreased to raise the current provided by third transistor 327 and fifth transistor 329, thus increasing the power consumed by power management system 110.

In some embodiments, controller device 410 can monitor the current at supply voltage 115 (e.g. load current 252), compare the monitored current to one or more predetermined current thresholds, and adjust the number of selected transistors 430₀-430_{N} accordingly. For example, if the monitored current at supply voltage 115 is above a predetermined current threshold (e.g., indicating an increase in load current 252 consumed by load circuit 250), then controller device 410 can decrease the number of selected transistors 430₀-430_{N}—and vice versa. In another example, controller device 410 can compare the monitored current to multiple predetermined current thresholds and incrementally adjust the number of selected transistors 430₀-430_{N} accordingly e.g., decrease the number of selected transistors 430₀-430_{N} as load current 252 rises above a first predetermined current threshold and further decrease the number of selected transistors 430₀-430_{N} as load current 252 rises above a second predetermined current threshold higher than the first predetermined current threshold. In turn, controller device 410 can have finer control of the power consumed by power management system 110.

Referring to FIG. 3, a gate terminal of fourth transistor 328 can be electrically coupled to second reference voltage source 323, and a source terminal of fifth transistor 329 can be electrically coupled to a drain terminal of fifth transistor 329. Fourth transistor 328 can be an NMOS transistor and second reference voltage source 323 can be a bandgap voltage reference circuit, according to some embodiments. The arrangement of fourth transistor 328 and fifth transistor 329 can have a cascode circuit topology, where a voltage at the drain terminal of fifth transistor 329 can be set to a stable voltage level substantially equal to second reference voltage source 323 minus a gate-to-source voltage of fourth transistor 328.

Referring to FIG. 3, a source terminal of first transistor 325 can be electrically coupled to first reference voltage source 322, and a gate terminal of first transistor 325 can be electrically coupled to a drain terminal of first transistor 325. First transistor 325 can be a PMOS transistor and first reference voltage source 322 can be a bandgap voltage reference circuit, according to some embodiments. The arrangement of first transistor 325 can have a diode-connected circuit topology, and the gate terminal of first transistor 325 can be set to a stable voltage level substantially equal to first reference voltage source 322 minus a source-to-gate voltage of first transistor 325. In turn, this stable voltage level is provided to the gate terminals of first control transistor 210 and second control transistor 211.

Referring to FIG. 3, the arrangement of first current source circuit 321, fourth transistor 328, and fifth transistor 329 provides a voltage level to a gate terminal 218 of pass device 240. For example, a resistance across fourth transistor 328 and fifth transistor 329 and the current flowing through these transistors (based on first current source circuit 321 and second current source circuit 324) can generate the voltage level at gate terminal 218 of pass device 240. In some embodiments, the voltage level at gate terminal 218 of pass device 240 provided by the arrangement of first current source circuit 321, fourth transistor 328, and fifth transistor 329 can be associated with an operating point of pass device 240 when no load current 252 is consumed by load circuit 250 (e.g., in the absence of current/voltage fluctuations at supply voltage 115 due to an activation/deactivation of one or more circuits in load circuit 250). First current source circuit 321 can be electrically coupled to a power supply voltage 216 (e.g., 1.0 V, 1.2 V, 1.8 V, 2.4 V, 3.3 V, and 5.0 V). In some embodiments, first current source circuit 321 can include an arrangement of transistors that provide a substantially constant current, such as transistors arranged in a common source configuration.

Referring to FIG. 3, in some embodiments, power management system 110 can have a FVF LDO regulator circuit topology (also referred to herein as “FVF LDO regulator circuit 110”). FVF LDO regulator circuit 110 can include a first loop portion and a second loop portion. The first loop portion can include first control transistor 210, fourth transistor 328, fifth transistor 329, first current source circuit 321, and pass device 240, according to some embodiments. The second loop portion can include second control transistor 211, resistor device 230, second capacitor device 230, and pass device 240, according to some embodiments.

In some embodiments, the first loop portion can serve as a DC regulation loop for FVF LDO regulator circuit 110. For example, first control transistor 210 can operate as a voltage follower circuit, where a voltage at its source terminal is equal to a voltage at its gate terminal (V_{g_210})—e.g., first reference voltage source 322—plus a gate-to-source voltage of first control transistor 210 (V_{gs_210}). Put differently, a voltage level at supply voltage 115 (which is electrically coupled to the source terminal of first control transistor 210) can be set to [V_{g_210}+V_{gs_210}], according to some embodiments. In some embodiments, first control transistor 210 can be a PMOS transistor and pass device 240 can be a PMOS power transistor.

During a first transient event where load circuit 250 transitions from a lower load current 252 to a higher load current 252 (e.g., due to one or more circuits being active in load circuit 250), supply voltage 115 is pulled down in voltage level. In turn, the source-to-gate voltage of first control transistor 210 is also pulled down, which pulls down a voltage level at gate terminal 218 of pass device 240. Also, as supply voltage 115 is pulled down during the first transient event, gate terminal 218 of pass device 240 is also pulled down via first capacitor device 212. In response, a gate-to-source voltage of pass device 240 rises, thus increasing a current flowing through pass device 240 to source load circuit 250 during the first transient event.

Conversely, during a second transient event where load circuit 250 transitions from a higher load current 252 to a lower load current 252 (e.g., due to one or more circuits being inactive in load circuit 250), supply voltage 115 rises in voltage level. In turn, the source-to-gate voltage of first control transistor 210 also rises, which raises the voltage level at gate terminal 218 of pass device 240. Also, as supply voltage 115 rises during the second transient event, gate terminal 218 of pass device 240 also rises via first capacitor device 212. In response, a gate-to-source voltage of pass device 240 is decreased, thus decreasing a current flowing through pass device 240 to source load circuit 250 during the second transient event.

For the first and second transient events, the first loop portion of FVF LDO regulator circuit 110 can have a bandwidth (e.g., a range of frequencies associated with fluctuations in load current 252 that the first loop portion can handle) based on the following relationship: a summation of a transconductance of pass device 240 (g_{m_240}) and a transconductance of first control transistor 210 (g_{m_210}), in which the summation is divided by third capacitor device 214 (C₂₁₄)—i.e., Bandwidth_{first_loop}=[(g_{m_240})+(g_{m_210})]/C₂₁₄—according to some embodiments. Based on this relationship, the bandwidth of the first circuit loop can be increased by increasing the transconductance of pass device 240 and/or the transconductance of first control transistor 210. To increase the transconductances of pass device 240 and first control transistor 210, the circuit area of these components can be increased. Consequently, the size of the first loop portion—and thus the overall size of FVF LDO regulator circuit 110—is also increased.

To increase the bandwidth of FVF LDO regulator circuit 110, while minimizing the circuit area impact to FVF LDO regulator circuit 110, the second loop portion of FVF LDO regulator circuit 110 can be implemented. In some embodiments, with the second loop portion, FVF LDO regulator circuit 110 can extend its bandwidth based on the following relationship: a summation of a transconductance of pass device 240 (g_{m_240}) multiplied by a first factor (K) and a transconductance of first control transistor 210 (g_{m_210}), in which the summation is divided by third capacitor device 214 (C₂₁₄)—i.e., Bandwidth_{second_loop}=[(K·g_{m_240})+(g_{m_210})]/C₂₁₄. The first factor K can be based on the following relationship: a product of a second factor (α), a transconductance of second control transistor 211, and resistance of resistor device 230 (R₂₃₀) i.e., K=α·g_{m_211}·R₂₃₀—according to some embodiments. In some embodiments, the second factor (α) can between about 0.3 and about 0.6. Thus, based on the resistance for resistor device 230 (R₂₃₀), the bandwidth of FVF LDO regulator circuit 110 can be increased and lead to a faster transient response for FVF LDO regulator circuit 110.

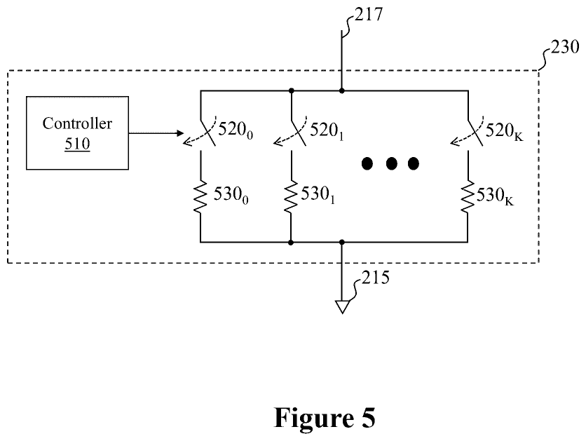

FIG. 5 is an illustration of an adjustable resistor device 230 in the second loop portion of FVF LDO regulator circuit 110, according to some embodiments. Adjustable resistor device 230 is electrically coupled to a source terminal 217 of second control transistor 211 and to ground supply voltage 215. A controller device 510 can activate and deactivate (e.g., close and open, respectively) switch devices 520₀-520_{K} electrically coupled to corresponding to resistor devices 530₀-530_{K} (where K≥1 and each of resistor devices 530₀-530_{K} is representative of resistor device 230) to adjust an effective resistance across selected resistor devices 530₀-530_{K}. As a number of resistor devices 530₀-530_{K} are selected (e.g., increasing the number of resistor devices 530₀-530_{K} electrically coupled to one another in parallel), the resistance across selected resistor devices 530₀-530_{K} decreases. Conversely, as the number of resistor devices 530₀-530_{K} are deselected (e.g., decreasing the number of resistor devices 530₀-530_{K} electrically coupled to one another in parallel), the resistance across selected resistor devices 530₀-530_{M} increases. In some embodiments, to increase the bandwidth of FVF LDO regulator circuit 110, controller device 510 can activate a particular number of switch devices 520₀-520_{K} to achieve the desired resistance for resistor device 230 (R₂₃₀).

Referring to FIG. 3, in addition to extending the bandwidth of FVF LDO regulator circuit 110, the second loop portion creates an enhanced Miller effect at the drain terminal of fourth transistor 328, according to some embodiments. For example, an equivalent capacitance at the drain terminal of fourth transistor 328 can be substantially equal to the first factor K (e.g., K=α·g_{m_211}·R₂₃₀) multiplied by a capacitance of first capacitor device 212 (C₂₁₂)—i.e., C_{equivalent}=K·C₂₁₂. With the first factor K, a size of first capacitor device 212 can be decreased to meet desired frequency response and stability characteristics of FVF LDO regulator circuit 110. In some embodiments, second capacitor device 213 can be implemented for stability compensation for the second loop portion.

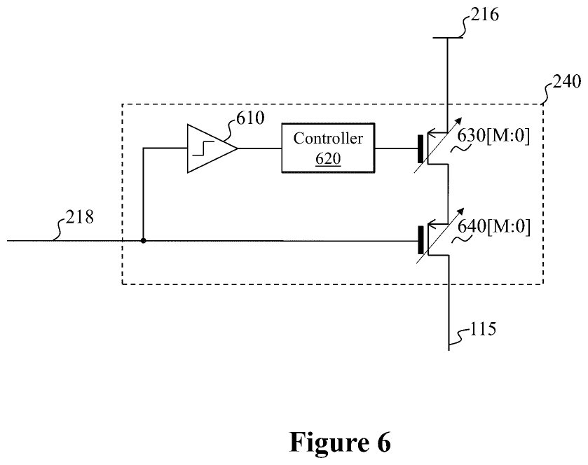

Further, in addition to the providing the enhanced Miller effect, the second loop of FVF LDO regulator circuit 110 provides an adjustable pass device 240 to optimize power consumption by FVF LDO regulator circuit 110. FIG. 6 is an illustration of an adjustable pass device 240 in the second loop portion of FVF LDO regulator circuit 110, according to some embodiments. Adjustable pass device 240 is electrically coupled to supply voltage 115, to power supply voltage 216, and to a drain terminal of fourth transistor 328 (via gate terminal 218). Adjustable pass device 240 includes a comparator circuit 610, a controller device 620, input/output (I/O) transistors 630₀-630_{M}, and pass transistors 640₀-640_{M} (where M≥1 and each of pass transistors 640₀-640_{M} is representative of pass device 240). In some embodiments, each of I/O transistors 630₀-630_{M} is electrically coupled to each of corresponding pass transistors 640₀-640_{M}. In some embodiments, each of I/O transistors 630₀-630_{M} and pass transistors 640₀-640_{M} can be a PMOS power transistor.

Controller device 620 can activate and deactivate (e.g., turn on and turn off, respectively) I/O transistors 630₀-630_{M} to vary a number of pass transistors 640₀-640_{M} electrically coupled between power supply voltage 216 and supply voltage 115 (e.g., varying the number of pass transistors 640₀-640_{M} electrically coupled to one another in parallel). In some embodiments, controller device 620 can incrementally activate and deactivate transistors 630₀-630_{M} based on voltage information provided by comparator circuit 610.

In some embodiments, comparator circuit 610 monitors a voltage level at gate terminal 218 based on transient events associated with load current 252. When monitoring load current 252, comparator circuit 610 can sample the voltage level at gate terminal 218 over a predetermined period of time and compare the sampled voltage level to a predetermined voltage threshold level, according to some embodiments. The predetermined voltage threshold level can be based on a voltage level that maintains particular operating voltages for various circuit nodes in FVF LDO regulator circuit 110, according to some embodiments. For example, a design of FVF LDO regulator circuit 110 may require a drain terminal of fourth transistor 328 to be in an operating voltage level around a mid-point between power supply voltage 216 (e.g., 1.0 V, 1.2 V, 1.8 V, 2.4 V, 3.3 V, and 5.0 V) and ground supply voltage 215 (e.g., 0 V). In this example, the predetermined voltage level can be set to a value to meet this operating voltage level.

Referring to FIG. 3 and during a first transient event where load circuit 250 transitions from a lower load current 252 to a higher load current 252 (e.g., due to one or more circuits being active in load circuit 250), supply voltage 115 is pulled down in voltage level. In turn, the source-to-gate voltage of first control transistor 210 is also pulled down, which pulls down a voltage level at gate terminal 218. Also, as supply voltage 115 is pulled down during the first transient event, gate terminal 218 is also pulled down via first capacitor device 212. Referring to FIG. 6, comparator circuit 610 can monitor the pulled-down voltage level at gate terminal 218 by, for example, comparing the pulled-down voltage level to the predetermined voltage threshold level. If the pulled-down voltage level is below the predetermined voltage threshold level, comparator circuit 610 can provide this indication to controller device 620. In response, controller device 620 can activate (e.g., turn on) one or more I/O transistors 630₀-630_{M} to increase the number of pass transistors 640₀-640_{M} electrically coupled between power supply voltage 216 and supply voltage 115 (e.g., increase the number of pass transistors 640₀-640_{M} electrically coupled to one another in parallel), thus increasing a current provided by power supply voltage 216 to supply voltage 115 and enhancing a transient response of FVF LDO regulator circuit 110.

Conversely, during a second transient event where load circuit 250 transitions from a higher load current 252 to a lower load current 252 (e.g., due to one or more circuits being inactive in load circuit 250), supply voltage 115 rises in voltage level. In turn, the source-to-gate voltage of first control transistor 210 also rises, which raises the voltage level at gate terminal 218. Also, as supply voltage 115 rises during the second transient event, gate terminal 218 also rises via first capacitor device 212. Referring to FIG. 6, comparator circuit 610 can monitor the rise in voltage level at gate terminal 218 by, for example, comparing the rise in voltage level to the predetermined voltage threshold level. If the rise in voltage level is above the predetermined voltage threshold level, comparator circuit 610 can provide this indication to controller device 620. In response, controller device 620 can deactivate (e.g., turn off) one or more I/O transistors 630₀-630_{M} to decrease the number of pass transistors 640₀-640_{M} electrically coupled between power supply voltage 216 and supply voltage 115 (e.g., decrease the number of pass transistors 640₀-640_{M} electrically coupled to one another in parallel), thus decreasing the current provided by power supply voltage 216 to supply voltage 115 and reducing power consumption by FVF LDO regulator circuit 110.

The above embodiments describe a power management system that includes an FVF LDO regulator circuit. The FVF LDO regulator circuit can include a first loop portion and a second loop portion. The first loop portion can serve as a DC regulation loop for the FVF LDO regulator circuit. The first loop portion can include an adjustable current source circuit to provide a bias current to the FVF LDO regulator circuit based on a mode of operation (e.g., a low power mode of operation and a high power mode of operation). The second loop portion can increase a bandwidth of the FVF LDO regulator circuit, while minimizing circuit area impact to the FVF LDO regulator circuit. For example, the bandwidth can be tuned by an adjustable resistor device in the second loop portion. In addition to increasing the bandwidth, the second loop portion can include an adjustable pass device to adjust a power consumption of the FVF LDO regulator circuit based on load current consumed by the load circuit.

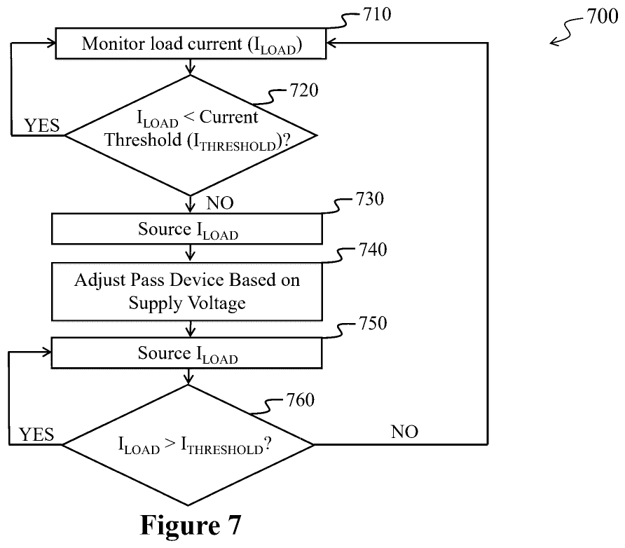

FIG. 7 is an illustration of a method 700 for operating a power management system electrically coupled to a load circuit, according to some embodiments. For illustrative purposes, the operations in method 700 will be described with reference to power management system 110 shown in FIGS. 1-6. Other representations of power management systems and associated waveforms are within the scope of the present disclosure. Also, additional operations may be performed between various operations of method 700 and may be omitted merely for clarity and ease of description. The additional operations can be provided before, during, and/or after method 700, in which one or more of these additional operations are briefly described herein. Moreover, not all operations may be needed to perform the disclosure provided herein. Additionally, some of the operations may be performed simultaneously or in a different order than shown in FIG. 7. In some embodiments, one or more other operations may be performed in addition to or in place of the presently-described operations.

At operation 710, a load current consumed by a load circuit is monitored by a power management system. Referring to FIG. 4, controller device 410 can sample load current 252 consumed by load circuit 250 over a period of time and compare the sampled load current to a predetermined current threshold level, according to some embodiments. The predetermined current threshold level can be based on an activity level of load circuit 250. For example, if load circuit 250 is idle and draws little to no load current 252 from power management system 110, then the predetermined current threshold level can be set to a value indicative of this operating condition.

Referring to FIG. 7, at operation 720, if the load current is below a predetermined current threshold level, method 700 returns to operation 710. Referring to FIG. 4, if load current 252 is below the predetermined threshold value, controller device 410 can select one or more transistors 430₀-430_{N} to decrease the current (e.g., the bias current) provided by third transistor 327 and fifth transistor 329 to minimize the power consumed by power management system 110.

Referring to FIG. 7, at operation 730, if the load current is above the predetermined current threshold level (from operation 720), the power management system sources the load current. Referring to FIG. 4, if load circuit 250 is active and draws load current 252 that is above the predetermined current threshold level, then controller device 410 can deselect one or more transistors 430₀-430_{N} to increase the current (e.g., the bias current) provided by third transistor 327 and fifth transistor 329, thus increasing the power consumed by power management system 110 when sourcing load current 252.

Referring to FIG. 7, at operation 740, a pass device of the power management system is adjusted based on a supply voltage (or a voltage level indicative of the supply voltage). Referring to FIG. 6, in some embodiments, comparator circuit 610 monitors a voltage level at gate terminal 218 (e.g., a voltage level indicative of supply voltage 115) based on transient events associated with load current 252. When monitoring load current 252, comparator circuit 610 can sample the voltage level at gate terminal 218 over a predetermined period of time and compare the sampled voltage level to a predetermined voltage threshold level, according to some embodiments. As discussed above, the predetermined voltage threshold level can be based on a voltage level that maintains particular operating voltages for various circuit nodes in FVF LDO regulator circuit 110, according to some embodiments.

Comparator circuit 610 can monitor a pulled-down voltage level at gate terminal 218 by, for example, comparing the pulled-down voltage level to the predetermined voltage threshold level. If the pulled-down voltage level is below the predetermined voltage threshold level, comparator circuit 610 can provide this indication to controller device 620. In response, controller device 620 can activate (e.g., turn on) one or more I/O transistors 630₀-630_{M} to increase the number of pass transistors 640₀-640_{M} electrically coupled between power supply voltage 216 and supply voltage 115 (e.g., increase the number of pass transistors 640₀-640_{M} electrically coupled to one another in parallel), thus increasing a current provided by power supply voltage 216 to supply voltage 115 and enhancing a transient response of FVF LDO regulator circuit 110.

Also, comparator circuit 610 can monitor a rise in voltage level at gate terminal 218 by, for example, comparing the rise in voltage level to the predetermined voltage threshold level. If the rise in voltage level is above the predetermined voltage threshold level, comparator circuit 610 can provide this indication to controller device 620. In response, controller device 620 can deactivate (e.g., turn off) one or more I/O transistors 630₀-630_{M} to decrease the number of pass transistors 640₀-640_{M} electrically coupled between power supply voltage 216 and supply voltage 115 (e.g., decrease the number of pass transistors 640₀-640_{M} electrically coupled to one another in parallel), thus decreasing the current provided by power supply voltage 216 to supply voltage 115 and reducing power consumption by FVF LDO regulator circuit 110.

Referring to FIG. 7, at operation 750, the power management system continues to source the current load.

Referring to FIG. 7, at operation 760, if the current load is greater than the predetermined current threshold level (from operation 720), then the power management system continues to source the current load at operation 750. Referring to FIG. 4, if load circuit 250 is active and draws load current 252 that is above the predetermined current threshold level, then controller device 410 can deselect one or more transistors 430₀-430_{N} to increase the current (e.g., the bias current) provided by third transistor 327 and fifth transistor 329.

After load current 252 falls below the predetermined current threshold value, the power management system continues to monitor the load current consumed by the power management system at operation 710. Further, referring to FIG. 4, if load circuit 250 is inactive and draws little to no load current 252 that is below the predetermined current threshold level, then controller device 410 can select one or more transistors 430₀-430_{N} to decrease the current (e.g., the bias current) provided by third transistor 327 and fifth transistor 329, thus decreasing the power consumed by power management system 110.

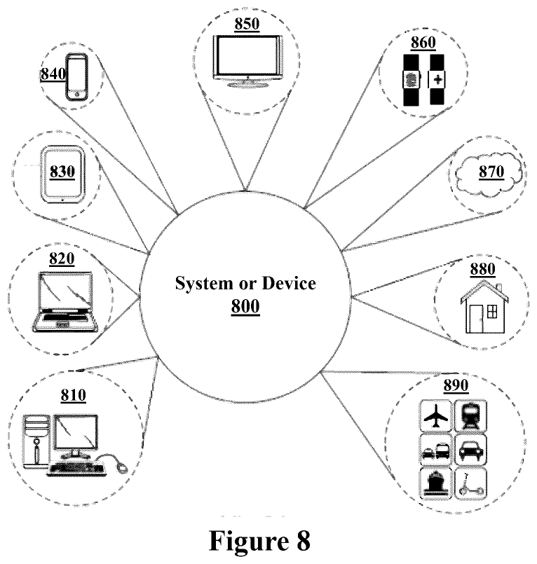

FIG. 8 is an illustration of exemplary systems or devices that can include the disclosed embodiments. System or device 800 can incorporate one or more of the disclosed embodiments in a wide range of areas. For example, system or device 800 can be implemented in one or more of a desktop computer 810, a laptop computer 820, a tablet computer 830, a cellular or mobile phone 840, and a television 850 (or a set-top box in communication with a television).

Also, system or device 800 can be implemented in a wearable device 860, such as a smartwatch or a health-monitoring device. In some embodiments, the smartwatch can have different functions, such as access to email, cellular service, and calendar functions. Wearable device 860 can also perform health-monitoring functions, such as monitoring a user's vital signs and performing epidemiological functions (e.g., contact tracing and providing communication to an emergency medical service). Wearable device 860 can be worn on a user's neck, implantable in user's body, glasses or a helmet designed to provide computer-generated reality experiences (e.g., augmented and/or virtual reality), any other suitable wearable device, and combinations thereof.

Further, system or device 800 can be implemented in a server computer system, such as a dedicated server or on shared hardware that implements a cloud-based service 870. System or device 800 can be implemented in other electronic devices, such as a home electronic device 880 that includes a refrigerator, a thermostat, a security camera, and other suitable home electronic devices. The interconnection of such devices can be referred to as the “Internet of Things” (IoT). System or device 800 can also be implemented in various modes of transportation 890, such as part of a vehicle's control system, guidance system, and/or entertainment system.

The systems and devices illustrated in FIG. 8 are merely examples and are not intended to limit future applications of the disclosed embodiments. Other example systems and devices that can implement the disclosed embodiments include portable gaming devices, music players, data storage devices, and unmanned aerial vehicles.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

Unless stated otherwise, the specific embodiments are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A circuit, comprising:
a pass device;
a first control transistor comprising a first gate terminal, a first source/drain (S/D) terminal electrically coupled to the pass device, and a second S/D terminal;
a current bias and voltage bias device electrically coupled to the second S/D terminal of the first control transistor;
a second control transistor comprising a second gate terminal electrically coupled to the first gate terminal, a third S/D terminal electrically coupled to the first S/D terminal and the pass device, and a fourth S/D terminal; and
a resistor device electrically coupled to the fourth S/D terminal of the second control transistor.

2. The circuit of claim 1, further comprising:
a first capacitor device electrically coupled to the pass device, the first S/D terminal of the first control transistor, and the third S/D terminal of the second control transistor; and
a second capacitor device electrically coupled to the pass device and to the fourth S/D terminal of the second control transistor.

3. The circuit of claim 2, wherein the pass device comprises a power transistor with a gate terminal electrically coupled to the first capacitor and to the second capacitor.

4. The circuit of claim 1, wherein the pass device comprises:
a plurality of first power transistors;
a plurality of second power transistors electrically coupled to the plurality of first power transistors, respectively; and
a controller device configured to activate one or more of the plurality of first power transistors to pass a power supply voltage to the first S/D terminal of the first control transistor and to the third S/D terminal of the second control transistor.

5. The circuit of claim 4, wherein the controller device is further configured to:
activate one or more of the plurality of first power transistors in response to a supply voltage associated with a load current rising above a predetermined voltage threshold level value; and
deactivate one or more of the plurality of first power transistors in response to the supply voltage being below the predetermined voltage threshold value.

6. The circuit of claim 1, wherein the current bias and voltage bias device comprises:
a reference voltage source configured to provide a reference voltage to the first gate terminal of the first control transistor and to the second gate terminal of the second control transistor; and
a current source circuit configured to provide a bias current to the first control transistor.

7. The circuit of claim 6, wherein the current source circuit comprises an adjustable diode-connected transistor in a current mirror circuit to adjust the bias current based on a load current consumed by a load circuit.

8. The circuit of claim 1, wherein the resistor device comprises:
a plurality of switch devices;
a plurality of resistor devices electrically coupled to the plurality of switch devices, respectively; and
a controller device configured to activate one or more of the plurality of switch devices to adjust a resistance between the fourth S/D terminal of the second control transistor and ground.

9. A method, comprising:
sourcing, through a pass device of a low drop out (LDO) regulator circuit, a load current;
adjusting a resistance of the pass device in response to a voltage level associated with the load current being above a predetermined voltage threshold level; and
adjusting a current bias of the LDO regulator circuit in response to the load current being below a predetermined current threshold level.

10. The method of claim 9, further comprising:
monitoring the load current in response to the load current being below the predetermined current threshold level.

11. The method of claim 9, wherein sourcing the load current comprises sourcing the load current in response to the load current being above the predetermined current threshold level.

12. The method of claim 9, wherein adjusting the resistance of the pass device comprises:
sampling a voltage level of a gate terminal associated with the pass device;
comparing the sampled voltage level to the predetermined voltage threshold level;
in response to the sampled voltage level being below the predetermined voltage threshold level, activating one or more input/output (I/O) transistors associated with the pass device; and
in response to the sampled voltage level being above the predetermined voltage threshold level, deactivating the one or more I/O transistors associated with the pass device.

13. The method of claim 12, wherein activating the one or more I/O transistors comprises increasing a current provided by a power supply voltage to a load circuit associated with the load current.

14. The method of claim 12, wherein deactivating the one or more I/O transistors comprises decreasing a current provided by a power supply voltage to a load circuit associated with the load current.

15. The method of claim 9, wherein adjusting a current bias of the LDO regulator circuit comprises:
sampling the load current;
comparing the sampled load current to the predetermined current threshold level;
in response to the sampled load current being below the predetermined current threshold level, activating one or more transistors associated with a current mirror circuit; and
in response to the sampled load current being above the predetermined current threshold level, deactivating the one or more transistors associated with the current mirror circuit.

16. The method of claim 15, wherein activating the one or more transistors comprises decreasing a current provided by the current mirror circuit.

17. The method of claim 15, wherein deactivating the one or more transistors comprises increasing a current provided by the current mirror circuit.

18. A system, comprising:
a load circuit configured to generate a load current; and
a low drop out (LDO) regulator circuit configured to source the load current and comprising:
an adjustable pass device configured to increase a current provided by a power supply voltage to the load circuit in response to a supply voltage associated with the load current being below a predetermined voltage threshold;
a first control transistor electrically coupled to the adjustable pass device;
a second control transistor electrically coupled to the first control transistor and the pass device; and
an adjustable current source circuit configured to adjust a bias current based on the load current.

19. The system of claim 18, wherein the LDO regulator circuit further comprises:
an adjustable resistor device configured to adjust a resistance between the second control transistor and ground.

20. The system of claim 18, wherein the LDO regulator circuit further comprises:
a first capacitor device electrically coupled to the pass device, the first control transistor, and the second control transistor; and
a second capacitor device electrically coupled to the pass device and to the second control transistor.
